(19) United States
(12) Patent Application Publication
(10) Pub. No.: US 2016/0118818 A1
(43) Pub. Date: Apr. 28, 2016

(54) Lithium Battery System and Control Method Therefor

(71) Applicant: Hitachi, Ltd., Tokyo (JP)

(72) Inventor: Shin YAMAUCHI, Tokyo (JP)

(21) Appl. No.: 14/920,494

(22) Filed: Oct. 22, 2015

(30) Foreign Application Priority Data
Oct. 24, 2014 (JP) 2014-216811

(51) Int. Cl. H02J 7/00; H01M 10/052; H01M 10/44; H01M 10/46

(52) U.S. Cl. CPC H02J 7/007; H01M 10/46; H01M 10/052; H01M 10/44; H02J 7/0052

(57) ABSTRACT

Provided is a lithium battery system which utilizes at least one lithiumbattery capable of being charged and discharged, and includes at least a charger or a power converter capable of charging the lithium battery. When charging the lithium battery by the charger or the power converter, a charging end voltage at which the charging of the lithium battery is ended is set in accordance with a magnitude of a current during the charging, and the charger or the power converter is controlled based on the set charging end voltage. Thus, it is possible to expand the chargeable voltage range of the lithium battery system practically even in applications requiring a large current for charging.

### CLAIM OF PRIORITY

The present application claims priority from Japanese Patent application serial No. 2014-216811, filed on Oct. 24, 2014, the content of which is hereby incorporated by reference into this application.

### BACKGROUND OF THE INVENTION

1. Field of the Invention

The present invention relates to a lithium battery system and a control method for the system.

2. Description of Related Art

Many attempts have been actively undertaken across the world to maintain and protect the environment. There has been a progress in the use of natural energy, such as wind-power and solar energy generation, and the electrical operation of vehicles, trains, etc. Recently, in view of these circumstances, lithium-ion secondary batteries (hereinafter referred to as “lithiumbatteries”) have been expected to achieve high capacities and high output characteristics.

To make effective use of the lithium batteries, charging techniques are very important. If a lithium battery continues a charging after reaching the maximum state of charge, the lithium metal is precipitated on the negative electrode, which leads to reduced performance of the battery, the performance including its capacity and output. In the worst cases, the precipitated lithium might come into contact with the positive electrode to cause a short circuit in the battery, leading to reported accidents, such as smoking or ignition. That is, when charging a lithium battery, it is necessary to control the charging with high accuracy to avoid overcharging the battery while reaching the fully charged state as much as possible.

As such a charging system, Japanese Patent Application Laid-Open Publication No. 2011-176930 (Patent Document 1) has proposed a system in which a circuit including a voltage divider and an operational amplifier arranged in parallel with the lithiumbattery can be used to control the battery voltage during charging with high accuracy. This system can charge the battery closer to its fully charged state while eliminating the adverse effects, including a voltage drop due to a current detection resistor connected in series to the battery, as compared to a system that controls charging by measuring the batteryvoltage.

### SUMMARY OF THE INVENTION

A lithium battery system of the present invention is provided which utilizes at least one lithium battery capable of being charged and discharged, and includes at least a charger or a power converter capable of charging the lithium battery. When charging the lithium battery by the charger or the power converter, a charging end voltage at which the charging of the lithium battery is ended is set in accordance with a magnitude of a current during the charging, and the charger or the power converter is controlled based on the set charging end voltage.

Accordingly, the present invention can configure a practical lithium battery system that enables expansion of the chargeable voltage range even in applications requiring a large current for charging.

### BRIEF DESCRIPTION OF THE DRAWINGS

FIG. 1 is a schematic view showing an exemplary lithium battery system including a single cell;

FIG. 2 is a schematic view showing an exemplary lithium battery system including a plurality of cells;

FIG. 3 is a series of graphs showing an example of a conventional charging procedure in a battery system;

FIG. 4 is a graph showing an example of a charging method in a lithium battery system that restricts an SOC range of its lithium battery;

FIG. 5 is a schematic view showing an example of a distribution of Li ions in a negative electrode;

FIGS. 6A-6C are a series of graphs showing an example of an effect of a charging method according to the present invention;

FIG. 7 is a schematic view showing an example of a structure for controlling a charging in the present invention;

FIG. 8 is a flowchart showing an example of a charging control according to the present invention;

FIGS. 9A-9C are a series of graphs showing an example of a result of a charging control according to the present invention;

FIGS. 10A and 10B are a series of graphs showing an example of a result of a charging control according to the present invention.

### DETAILED DESCRIPTION OF THE PREFERRED EMBODIMENTS

The technique disclosed in Patent Document 1 proposes a method that can control the charging of the battery with high accuracy, but it has some disadvantages in the use of a lithium battery for various purposes. That is, in some purposes, including reduction of variations in output of the natural energy, energy recovery in deceleration and quick charging of vehicles or trains, the voltage of the battery might be increased during charging because of a large charging current. When a voltage corresponding to the full charge is reached, the charging current is designed to be limited. For this reason, in applications requiring a large current for charging, measures against these disadvantages are needed. For example, a battery is charged at a voltage in a range that does not reach the voltage corresponding to the full charge, under a condition of the expected maximum current. Alternatively, a plurality of lithium batteries is coupled in parallel to divide the current. Further, alternatively, a lithium battery with a greater capacity than necessary is used to make it difficult for the battery to increase its voltage.

In view of the foregoing background, the present invention proposes a charging system that can make maximum use of the performance of a lithium battery even when a large current is required for charging.

A lithium battery system according to one embodiment of the present invention will be described below with reference to the accompanying drawings.

[Outline of Power System to Which Battery System of the Present Invention is Applied]

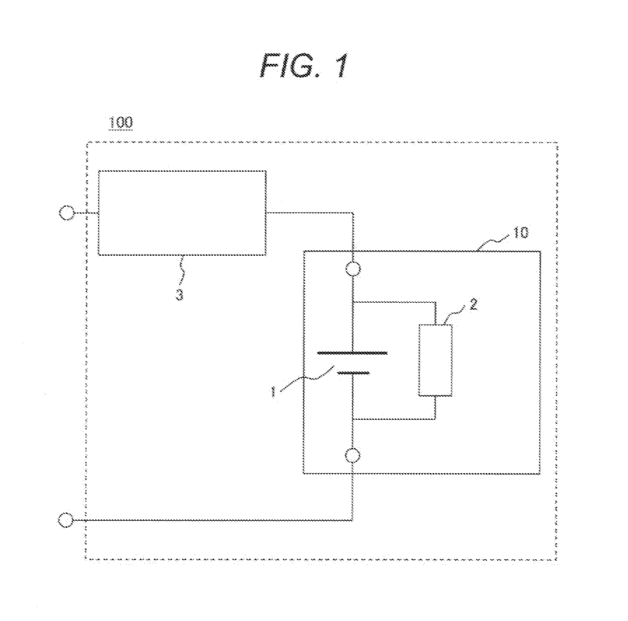

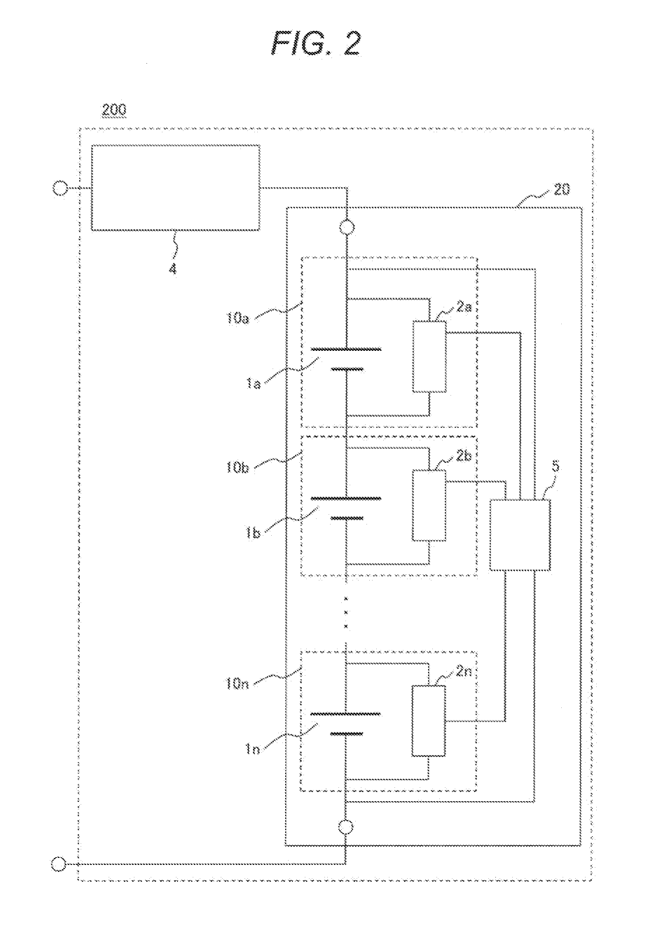

First, the outline of a power system to which a lithium battery system 100 according to the present invention is applied will be described with reference to FIGS. 1 and 2. FIG. 1 shows an example of the lithium battery system 100 that includes one lithium battery 10. The lithium battery 10 is configured of a battery cell 1 and a protection IC 2. Herein, “IC” is an abbreviation for integrated circuit. The battery cell 1 and the protection IC 2 are arranged in parallel with each other. The lithium battery 10 is charged by a charger 3. In this embodiment, the charger 3 is included in the battery system 100. Alternatively, the charger 3 may be provided outside the battery system 100.

The protection IC 2 monitors the state of charge of the cell 1 by measuring a voltage across both terminals of the cell 1. In addition to the voltage-based monitoring, there are some systems that monitor the temperature of the battery by installing a temperature sensor, and others that monitor the current during charging and discharging of the lithium battery by installing a current sensor.

FIG. 2 shows an example of a lithium battery system 200 that includes two or more lithium batteries 10. In use of the plurality of lithium batteries (10a, 10b . . . 10n), protection ICs (2a, 2b . . . 2n) for respective cells (1a, 1b . . . 1n) send information which includes a voltage and a temperature of the respective cells (1a, 1b . . . 1n) to a general IC 5. The general IC 5 determines the presence or absence of variations in voltage or temperature at the respective cells (1a, 1b . . . 1n) as well as the presence or absence of an abnormal one among the respective cells based on the information from the protection ICs (2a, 2b . . . 2n).

A lithium battery group 20 is connected to and charged by a power converter (charger) 4.

Additionally, the general IC 5 measures a total voltage which is an entire voltage of the lithium battery group 20, a temperature of the lithium battery group 20, a current during charging and discharging of the battery, and the like. Although not shown in FIG. 2, the lithium batteries (10a, 10b . . . 10n) can be provided with a switch that connects to and disconnects from a main circuit through which current flows during charging and discharging of the battery, or with a fuse that is installed in the event of flowing of abnormal current in some cases. The lithiumbattery system 200 for carrying out the present invention does not differ so much from a conventional system structure.

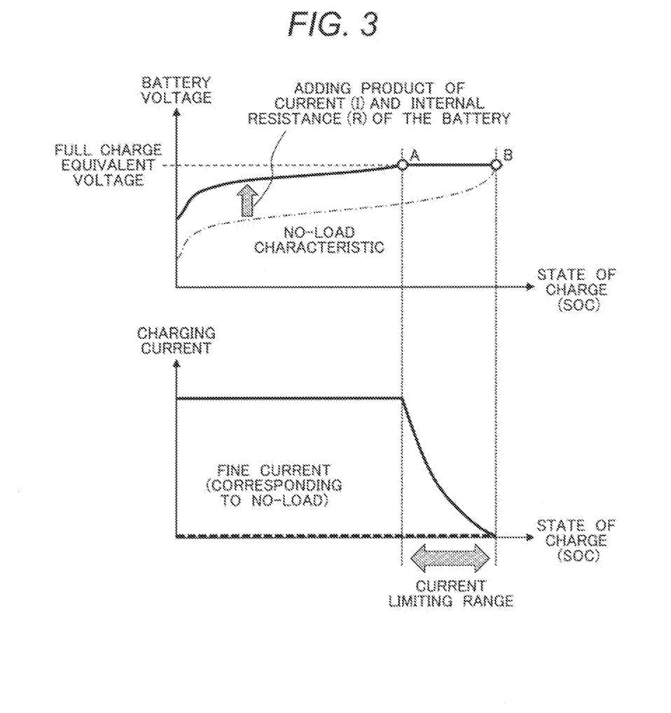

FIG. 3 shows an example of a conventional charging procedure in such a battery system 100. Here, a description will be given of a case of providing one lithium battery 10 by way of example. In charging the lithiumbattery 10, a battery voltage is obtained by adding an IR component derived from a product of a current (I) and an internal resistance (R) of the battery to a no-load characteristic value (indicated by an alternate long and short dash line of FIG. 3) (see the arrow in the upper diagram of FIG. 3). Thus, the relationship between the battery voltage actually measured and the state of charge (SOC) of the battery tends to show a solid line in the upper diagram of FIG. 3.

The no-load characteristics are indicated by a profile of the battery voltage when charging the battery with a fine current close to zero. A full charge equivalent voltage is a voltage at which the SOC of the battery is maximized based on the no-load characteristics of the battery.

In the conventional charging procedure, charging is controlled by limiting the current not to exceed the full charge equivalent voltage, after the battery voltage observed from the outside reaches the full charge equivalent voltage (reaches a point A in the upper diagram of FIG. 3) until the SOC is maximized or reaches a predetermined state of charge (reaches a point B in the upper diagram of FIG. 3). Thus, as the charging current is increased for the purpose of quick charging in the conventional charging procedure, the battery voltage might possibly reach the full charge equivalent voltage at an earlier stage, whereby the battery will be charged with the limiting charging current. As a result, it will take a longer time to fully charge the battery because the charging current is limited.

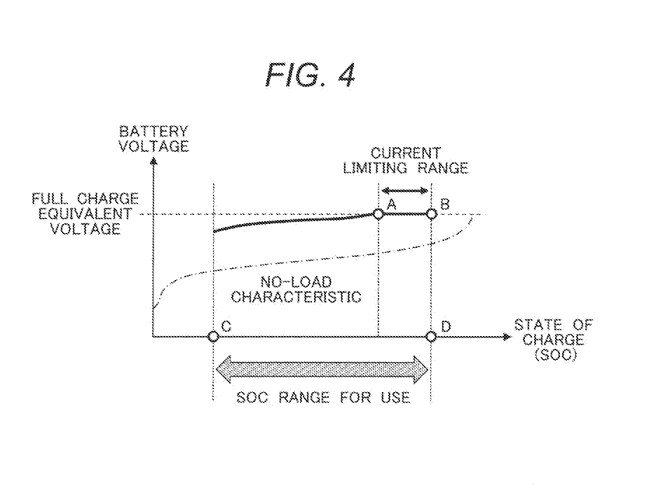

FIG. 4 shows an example of a charging method in a lithium battery system that restricts the SOC range for use when applying the lithium battery. The lithium battery tends to easily degrade its performance if the SOC range for use is widened. In particular, in applications, such as vehicle, trains, and other industrial applications, that cannot easily replace a lithium battery, the lithium battery system performs control such that the SOC range for use is restricted to make the battery usable in the SOC from a point C to a point D in FIG. 4. Even this case has the state or phenomenon in which the IR component derived from the product of the current (I) and the internal resistance (R) of the battery is added to the no-load characteristic value (indicated by an alternate long and short dash line of FIG. 4). Thus, in the conventional charging method, even if the SOC does not reach the fully charged state, when the battery voltage reaches the full charge equivalent voltage (reaches the point A of FIG. 4), the charging current is controlled to be limited not to make the battery voltage exceed the full charge equivalent voltage until a target SOC (indicated by the point B of FIG. 4) is reached.

Note that the reason for limiting the charging current is that if the battery voltage exceeds the full charge equivalent voltage, lithium is precipitated on the negative electrode to form dendrites. If the charging is continued while the full charge equivalent voltage is exceeded, even though the SOC is in the fully charged state, the potential of the negative electrode will become substantially equal to that of the Li metal. Thus, Li ions are precipitated as the Li metal to form dendrites. However, there is no report that demonstrates the relationship between the formation of dendrites and a condition in which the charging is continued while the full charge equivalent voltage is exceeded with the SOC not reaching the fully charged state.

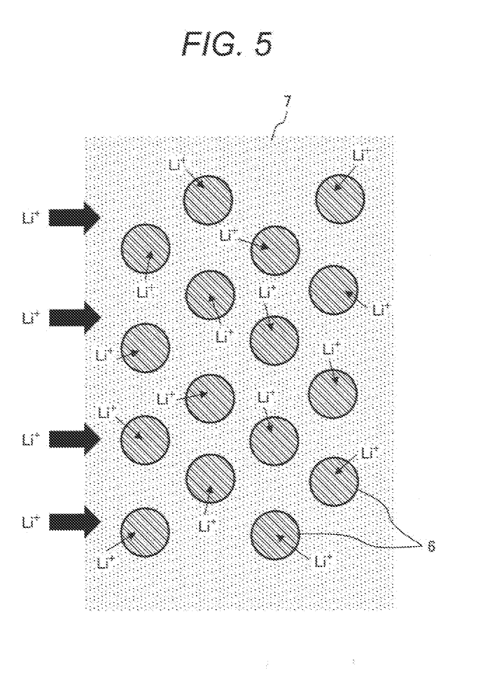

For this reason, the present invention has focused on the above-mentioned condition and the possibility of formation of the dendrites in a model of Li ion distribution during charging as shown in FIG. 5. FIG. 5 shows an example of the model of the flows of negative-electrode active materials 6 and Li ions in a negative electrode 7. An electrolyte is present around the active materials. Once charging is started, lithium ions are intercalated in an amount corresponding to the charging from the surroundings of the active materials into the active materials, and as a result, the Li-ion concentration in the electrolyte is decreased. In particular, when the battery is charged with a great current, causing a difference between the concentration of Li ions intercalated in the active materials and that of Li ions in the electrolyte, there also occurs a difference between free energy of the Li ions in the active material and that of Li ions in the electrolyte, depending on these concentrations. Such a difference in free energy generates an electromotive force. Thus, the potential of the negative electrode 7 is considered to include not only the potential based on the SOC, but also the electromotive force generated by the difference in concentration of the Li ions.

Therefore, according to the model described above, the potential of the negative electrode 7 includes the electromotive force that is caused by at least the difference in Li-ion concentration in a case where the battery voltage reaches the full charge equivalent voltage because of a large charging current during charging, though the SOC is not the fully charged state. This case does not mean that the potential of the negative electrode 7 reaches the same level as that of Li metal. That is, the voltage of the battery can be increased only by the electromotive force due to the difference in Li-ion concentration.

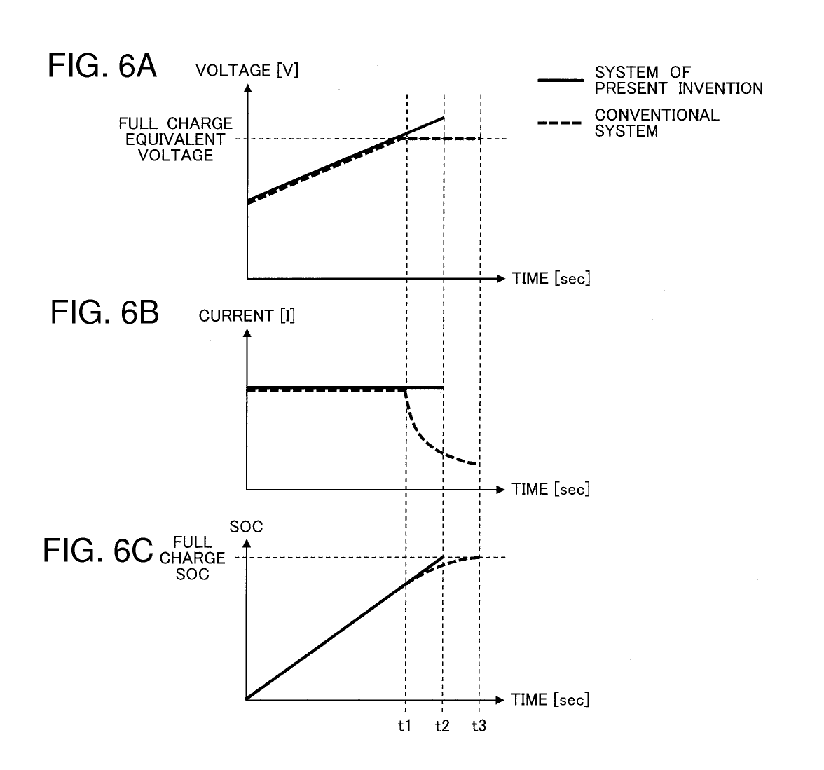

FIG. 6 shows an example of the effects of the charging method according to the present invention that utilizes the findings based on the above-mentioned model. Graph (a) shows data on the voltage plotted against the time; Graph (b) shows data on the current plotted against the time; and Graph (c) shows data on the SOC plotted against the time. In each of these figures, the solid line corresponds to the system of the present invention, and the dotted line corresponds to the conventional system. As mentioned above, aback electromotive force is caused inside the battery by the difference in Li-ion concentration. Thus, the inherent full charge equivalent voltage must be increased by the back electromotive force, compared to the voltage observed from the outside. In the conventional system, the current is limited after the battery voltage reaches the full charge equivalent voltage. However, when the charging is continued after the full charge equivalent voltage is reached for the above reason, the dendrites would not be formed until the charging voltage is increased up to a voltage obtained by adding the back electromotive force generated by the difference in Li-ion concentration. For this reason, the present invention can continue the charging at the voltage exceeding the full charge equivalent voltage without limiting the current until the end of the charging. The charging method of the present invention is appropriate for shortening the charging time and for charging with a large current.

In FIG. 6, Graph (a) is a diagram illustrating data on the voltage plotted against the time, showing that a voltage higher than the full charge equivalent voltage is applied. On the other hand, Graph (b) is a diagram illustrating data on the current plotted against the time, showing that the battery is charged without limiting the current until a time t2 even after a time t1 when the voltage reaches the full charge equivalent voltage. Graph (c) shows data on the SOC plotted against the time. Graph (c) shows that the fully charged state SOC is reached at the time t3 in the conventional system, but that the time required to fully charge the battery becomes shorter at the time t2 in the present invention.

As mentioned above, in the present invention, the charging voltage is increased up to the voltage obtained by adding the voltage corresponding to the back electromotive force generated according to the difference in Li-ion concentration, compared to the conventional system, thereby avoiding limiting the charging current. Such control can charge the battery more quickly while suppressing the generation of dendrites.

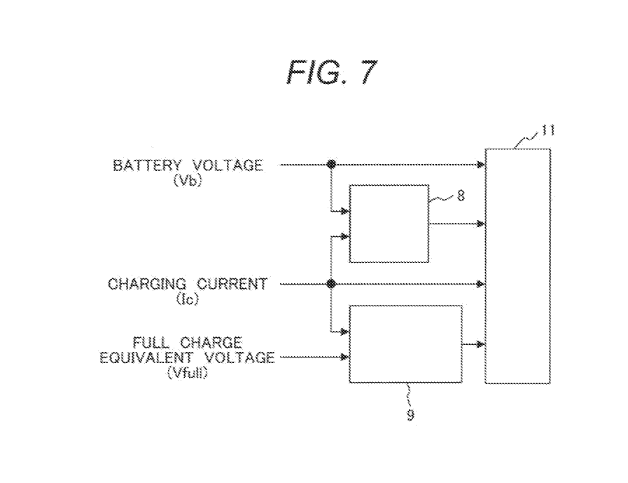

FIG. 7 shows an example of a block diagram of control logic for performing the charging procedure in the present invention. In the present invention, the control is performed in the charger 3 or power converter 4, but this is one of the charging procedures. Alternatively or additionally, the control function described above may be performed by the protection IC 2 or the general IC 5. Further, alternatively or additionally, the functions of a SOC computation portion 8 and a charging end voltage computation portion 9 may be performed by the protection IC 2 or the general IC 5, and the function of a current controller 11 may be performed by the charger 3 or power converter 4. Moreover, alternatively or additionally, the function of the SOC computation portion 8 may be performed by the protection IC 2 or the general IC 5, and the functions of the charging end voltage computation portion 9 and the current controller 11 may be performed by the charger 3 or the power converter 4.

A charging control is carried out to control the current by the current controller using information regarding a battery voltage (Vb), a charging current (Ic), the SOC (State of Charge) determined by the battery voltage and the charging current, and a charging end voltage (Vend) calculated based on the charging current and the full charge equivalent voltage previously determined by physical properties of the lithium battery. The full charge equivalent voltage corresponds to a voltage at which the state of charge determined according to the physical property values of the lithium battery 10 is maximized. A specific method for the current control will be described later. Here, the flow of the control information will be described. First, the battery voltage (Vb) and the charging current (Ic) are measured. The information on the measured battery voltage (Vb) is output to the SOC computation portion 8 and the current controller 11, and the information on the measured charging current (Ic) is output to the SOC computation portion 8, the charging end voltage computation portion 9, and the current controller 11. The SOC computation portion 8 determines the SOC by the existing method, and the information on the SOC determined is input to the current controller 11. On the other hand, the charging end voltage computation portion 9 receives the input of the information on a full charge equivalent voltage (Vfull) previously calculated. Then, the charging end voltage (Vend) is calculated using the information on the full charge equivalent voltage (Vfull) and the information on the charging current (Ic). Thereafter, the information on the charging end voltage (Vend) is output to the current controller 11. The current controller 11 calculates or determines the charging current control information based on the information on the battery voltage (Vb), the information on the SOC, the information on the charging current (Ic), and the information on the charging end voltage (Vend), which are input to the controller. The procedure performed by the charging end voltage computation portion will be described below with reference to Tables 1 and 2. Table 1 shows a table that is made to show the charging end voltages previously set according to the currents. In this case, this procedure can be achieved by directly making the table of the charging end voltages, or alternatively, by making a table that shows the amount of correction of the Vfull according to the charging current. Note that when as shown in Table 1, the relationship between the charging current and the charging end voltage is Ic1<Ic2<Ic3, the voltage Vend1 for the Ic1, the voltage Vend2 for the Ic2, and the voltage Vend3 for the Ic3 are respectively set to the following: Vend1<Vend2<Vend3. The reason for this is that the difference in lithium-ion concentration in the vicinity of the negative electrode varies depending on the charging current. As the charging current is decreased, a difference between the rate of lithium ions collected in the vicinity of the negative electrode and the rate of lithium ions intercalated into the negative electrode material becomes smaller. Thus, as the value of the charging current becomes smaller, the difference in voltage due to the difference in concentration will decrease. When the relationship of Vend1<Vend2<Vend3 is set for Ic1<Ic2<Ic3, the charging time can be shortened while suppressing the generation of dendrites. In this embodiment, as mentioned above, the Vend is calculated or measured in advance and is used to make the table, which is utilized for the control.

Table 2 shows the case of the procedure shown in Table 1 provided by considering the temperature of the battery. As the temperature of the battery increases, the resistance of the battery tends to decrease. Further, even at the same charging current, as the temperature of the battery becomes higher, the increase in voltage during charging of the battery becomes smaller. Therefore, when T1<T2<T3, the voltage Vend31 for the T1, the voltage Vend21 for the T2, and the voltage Vend1 1 for the T3 are respectively set to have the relationship of Vend31<Vend21<Vend11. Such setting can shorten the charging time while suppressing the generation of dendrites by considering information on the temperature of the battery. In this embodiment, the charging end voltages are previously mapped by use of the charging current and temperature in this way, thereby performing the charging control. Although the charging end voltages for the charging current of Ic2 and Ic3 are not described above, the charging end voltages have the relationships of Vend32<Vend22<Vend12, and Vend33<Vend23<Vend13, respectively. The charging end voltages for the temperatures of the battery are T1, T2 and T3 respectively satisfy the relationships of Vend11<Vend12<Vend13, Vend21<Vend22<Vend23, and Vend31<Vend32 <Vend33.

TABLE 1

| | CHARGING CURRENT | | |
|---|---|---|---|
| | (Ic) | | |
| | Ic₁ | Ic₂ | Ic₃ |
| CHARGING | Vend1 | Vend2 | Vend3 |
| END VOLTAGE | | | |
| (Vend) | | | |

Ic₁ < Ic₂ < Ic₃
Vend1 < Vend2 < Vend3

TABLE 2

| | (Ic) | | |
|---|---|---|---|
| TEMPERATURE | Ic₁ | Ic₂ | Ic₃ |
| T1 | Vend11 | Vend12 | Vend13 |
| T2 | Vend21 | Vend22 | Vend23 |
| T3 | Vend31 | Vend32 | Vend33 |

T1 < T2 < T3
Vend11 < Vend12 < Vend13
Vend31 < Vend21 < Vend11

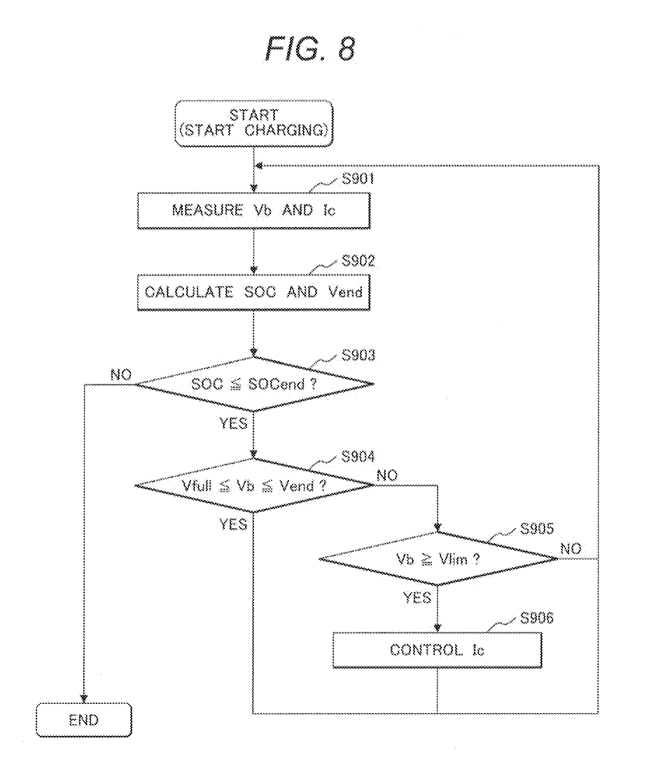

FIG. 8 shows a flowchart for performing the control logic in the present invention. After starting the charging of the battery, the battery voltage (Vb) and the charging current (Ic) are measured in step S901. Next, in step S902, the SOC is determined by the SOC computation portion 8 using the Vb and Ic, and then the charging end voltage (Vend) is calculated by the charging end voltage computation portion 9 using the Ic and the Vfull pre-stored in the controller as a numerical value.

In step S903, it is determined whether or not the determined SOC is equal to or less than an SOCend which is a predetermined value indicative of the end of charging. If No, the charging will be ended. Note that if Yes, it is determined whether the Vb is not less than the Vfull and not more than the Vend in step S904. If Yes in the determination of step S904, that is, when the Vb is determined to be not less than the Vfull and not more than the Vend, the charging is continued without limiting the charging current, and the operation returns to step S901. On the other hand, if No in the determination of step S904, that is, when the Vb is determined not to be not less than the Vfull and not more than the Vend, it is further determined whether or not the Vb reaches a voltage Vlim in step S905 which is an upper limit of voltage that is previously determined by the physical properties of the lithium battery and which can be applied to the lithium battery. Here, if No, the operation returns to step S901, in which the charging will be continued. If Yes, the Vb is less than the Vend, but has already reached the upper limit voltage Vlim. To avoid the further increase in voltage, the operation proceeds to step S906, in which the charging current is reduced, and then the operation returns to step S901.

Such control can charge the battery without limiting the charging current even in a range of voltage of the Vfull or higher at which the conventional control method limits the charging current, thereby enabling the quick charging of the battery. The Vlim is set to the upper limit voltage during charging, which can prevent the potential of the negative electrode from being substantially equal to the potential of

Li metal, while quickly charging the battery, thereby suppressing the generation of dendrites.

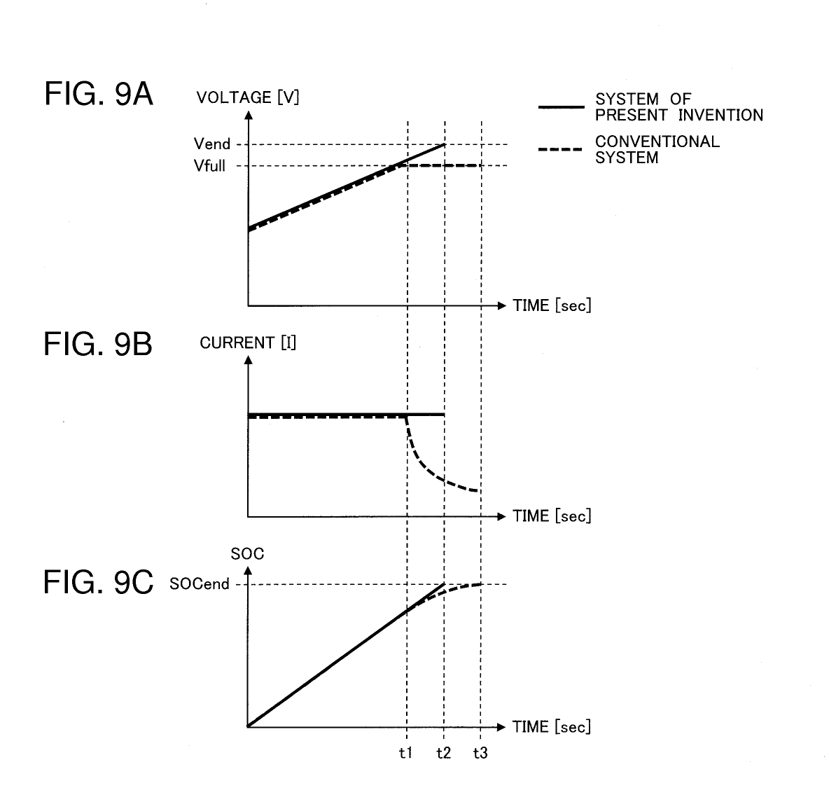

FIG. 9 shows an example of the time charts obtained when performing the charging control procedure in the present invention. Graph (a) shows data on the voltage plotted against the time; Graph (b) shows data on the current plotted against the time; and Graph (c) shows data on the SOC plotted against the time. Here, a description will be given of the example in which the battery can be charged while the Vb does not reach the Vlim. Note that to compare with the effect of a conventional system, an example of the conventional system will be designated by dotted lines in the figure. In the system of the present invention, once the charging is started, the charging current is constant to continue the charging of the battery. At this time, even when the Vb reaches the Vfull (or the time t1 is reached), the charging current is kept constant and not changed. As a result, the Vb also increases after exceeding the Vfull. Finally, when the Vb reaches the Vend (or the time t2 is reached), which is a voltage at which the SOC reaches the SOCend as the target charged state, the charging is ended. In the present invention, until the time T2 is reached, the current value is not limited and kept constant, which enables the high-speed charging.

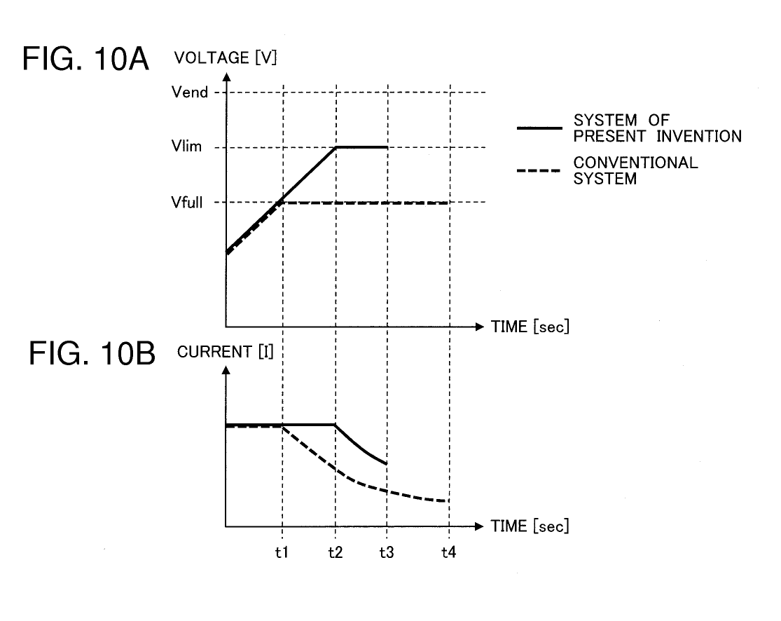

Next, FIG. 10 shows an example in which the Vb reaches the Vlim. In FIG. 10, Graph (a) shows data on the voltage plotted against the time; and Graph (b) shows data on the current plotted against the time. When the charging current is high, the Vend can be set to increase to exceed the Vlim. However, when the Vend actually exceeds the Vlim, the potential of the negative electrode might be substantially equal to the potential of the Li metal. Thus, there is a possibility that the generation of dendrites cannot be reduced. After the Vlim is reached, the current is preferably controlled to perform charging of the battery while not exceeding the Vlim. In this embodiment, the voltage reaches the Vlim at the time t2, and then the current is limited until the time t3 such that the voltage does not exceed the Vlim. As can be seen from Graph (b) of FIG. 10, the charging current is controlled in such a manner that limiting of the current starts at the time t2 and after that time the charging current value decreases. In this case, although not shown in the figure, the charging is ended after the SOC reaches the SOCend (the time t3 is reached). In such a case, the Vend may be previously calculated using the Vlim as the upper limit.

Now, the summary of the present invention will be described. The lithium battery system 100 of the present invention includes at least one lithium battery 10, and the charger 3 or power converter 4 that is capable of charging the lithium battery 10. When the charging current becomes large, the charger 3 or power converter 4 is characterized by performing control to increase the charging end voltage. The lithium battery system with such an arrangement can increase the charging voltage taking into consideration the difference in lithium-ion concentration in the vicinity of the negative electrode that is caused by the charging current. Thus, the lithium battery system of the present invention can more quickly charge the battery than the conventional charging system.

In the lithium battery system 100 of the present invention, the charging end voltage is set larger than the voltage at which the state of charge of the battery determined according to the physical properties of the lithium battery 10 is maximized. Such an arrangement can charge the lithium battery 10 at the higher voltage than that in the conventional charging system, thereby enabling quick charging.

In the lithium battery system 100 of the present invention, the charging end voltage is set larger than the voltage that maximizes the state of charge of the battery determined according to the physical properties of the lithium battery 10 by the electromotive force or higher caused depending on the ion concentration of the lithium battery 10. This arrangement can charge the lithium battery 10 at the higher voltage than that in the conventional charging system, thereby enabling quick charging.

In the lithium battery system 100 of the present invention, the charging end voltage is set to a voltage obtained by adding the electromotive force generated based on the ion concentration of the lithium battery 10 to the voltage that maximizes the state of charge of the battery determined according to the physical properties of the lithium battery 10. Such an arrangement can prevent the potential of the negative electrode from being substantially equal to the potential of Li metal while quickly charging the battery, thereby suppressing the generation of dendrites.

In the control method of the lithium battery system 100 in the present invention, the lithium battery system including at least one lithium battery 10 and the charger 3 or power converter 4 capable of charging the lithium battery 10, the charger 3 or power converter 4 is adapted to perform control not to limit a charging current value in the following cases : when a present state of charge (SOC) of the lithium battery 10 is determined to be lower than a state of charge (SOCend) thereof at the end of charging by comparison between the present state of charge (SOC) of the lithium battery 10 and the state of charge (SOCend) at the end of the charging; and when the voltage Vb is not less than the voltage Vfull and not more than the voltage Vend by comparison among the voltages (Vb), (Vfull), and (Vend), where Vb is a present voltage of the lithium battery 10, Vfull is a voltage at which a charged state determined according to the physical properties of the lithium battery 10 is maximized, and Vend is a charging end voltage. Such control does not limit the current in the SOC range where the conventional system limits the current, thereby enabling quick charging, compared to the conventional charging system.

Further, in the control method for the lithium battery system 100 of the present invention, the charger 3 or power converter 4 is adapted to perform control to limit the charging current value when the Vb is not in a range of not less than Vfull and not more than Vend, and when the present voltage (Vb) of the lithium battery 10 is equal to or higher than the upper limit of voltage (Vlim) that is previously determined by the physical properties of the lithium battery 10 and which can be applied to the lithium battery 10. Such control can prevent the potential of the negative electrode from being substantially equal to the potential of Li metal while quickly charging the battery, thereby suppressing the generation of dendrites.

The control method of the lithium battery system 100 in the present invention is characterized by that the charging end voltage (Vend) decreases as the temperature of the lithium battery 10 increases.

Although the embodiments of the present invention have been described above in detail, the present invention is not limited to the above-mentioned embodiments, and various modifications and changes can be made to those embodiments without departing from the spirit of the present invention described in the accompanied claims. For example, the embodiments described above have been described in detail to clarify the present invention, and the present invention is not necessarily limited only to the structure including all the arrangements described. A part of the structure of one embodiment can be replaced by a corresponding part of the structure of another embodiment. Further, the structure of another embodiment can be added to the structure of one embodiment. Moreover, a part of one structure in each embodiment can be embodied by addition, deletion, and replacement of another structure therein.

1. A lithium battery system comprising:
at least one lithium battery; and
a charger or a power converter capable of charging the lithium battery,
wherein the charger or the power converter performs a control to increase a charging end voltage when a charging current becomes large.

2. The lithium battery system according to claim 1,
wherein the charging end voltage is set larger than a voltage at which a state of charge of the lithium battery is maximized, the state of charge being determined in accordance with a physical property of the lithium battery.

3. The lithium battery system according to claim 2,
wherein the charging end voltage is set larger than the voltage at which the state of charge of the lithium battery is maximized by an electromotive force or higher generated based on an ion concentration of the lithium battery, the state of charge being determined in accordance with the physical property of the lithium battery.

4. The lithium battery system according to claim 2,
wherein the charging end voltage is a voltage obtained by adding an electromotive force generated based on an ion concentration of the lithium battery to the voltage at which the state of charge of the lithium battery is maximized, the state of charge being determined in accordance with the physical property of the lithium battery.

5. A method for controlling a lithium battery system,
the lithium battery system comprising at least one lithium battery, and a charger or a power converter capable of charging the lithium battery,
the method comprising the step of:
adapting the charger or the power converter not to limit a charging current value, when a present state of charge (SOC) of the lithium battery is determined to be lower than a state of charge (SOCend) thereof at end of charging by comparison between the present state of charge (SOC) of the lithium battery and the state of charge (SOCend) at the end of the charging, and further when a voltage Vb is not less than a voltage Vfull and not more than a voltage Vend by comparison among the voltages (Vb), (Vfull) and (Vend), where Vb is a present voltage of the lithium battery, Vfull is a voltage at which a state of charge determined in accordance with a physical property of the lithium battery is maximized, and Vend is a charging end voltage.

6. The method for controlling a lithium battery system according to claim 5,
wherein the charger or the power converter limit the charging current value when the Vb is not in a range of not less than the Vfull and not more than the Vend, and when the Vb of the lithium battery is equal to or higher than an upper limit of a voltage (Vlim) that is previously determined by the physical property of the lithium battery and which is to be applied to the lithium battery.

7. The method for controlling a lithium battery system according to claim 5,
wherein the charging end voltage (Vend) decreases as a temperature of the lithium battery increases.
